(19) United States
(12) Patent Application Publication
(10) Pub. No.: US 2009/0153457 A1
(43) Pub. Date: Jun. 18, 2009

(54) Display apparatus and method for driving the same

(75) Inventor: Eiji Kato, Kanagawa (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 12/289,996

(22) Filed: Nov. 10, 2008

(30) Foreign Application Priority Data
Dec. 12, 2007 (JP) 2007-321212

(51) Int. Cl. G09G 3/36

(52) U.S. Cl. 345/89

(57) ABSTRACT

A display apparatus includes a light source, a liquid crystal display element, and a signal generating unit. The signal generating unit includes first to third correction values calculation unit, and a correction value calculating unit. The first correction value calculation unit detects a gray scale of an image signal and calculates a first correction value on the basis of the detected gray scale. The second correction value calculation unit detects a polarity of a voltage component in response to the image signal and calculates a second correction value on the basis of the detected polarity. The third correction value calculation unit detects a wavelength and/or luminance of the light and calculates a third correction value on the basis of the detected wavelength and/or luminance. The correction value calculation unit calculates a correction value for correcting the voltage component on the basis of the first to third correction values.

### CROSS-REFERENCE TO RELATED APPLICATIONS

The present application claims benefit of priority of Japanese patent Application No. 2007-321212 filed in the Japanese Patent Office on Dec. 12, 2007, the entire disclosure of which is incorporated herein by reference.

### BACKGROUND OF THE INVENTION

1. Field of the Invention

The present invention relates to a display apparatus capable of preventing degradation in image quality of a display image, and a method for driving the display apparatus.

2. Description of Related Art

In recent years, a cathode ray tube (CRT) display has been replaced with a display apparatus equipped with a liquid crystal display element, and which is used in various apparatuses such as a TV set or a mobile device as well as a display apparatus for a personal computer (PC), because of its low power consumption or convenient portability.

The liquid crystal display element provided on the display apparatus includes a transparent substrate having pixel electrodes, a common substrate which is arranged to oppose the transparent substrate and has a common electrode, and a liquid crystal layer interposed between these substrates. Since the transmittance of light passed through the liquid crystal layer is varied by changing the strength of electric fields generated by the two electrodes, the liquid crystal display element utilizes this principle for adjusting a voltage difference between the two electrodes, so that desired images are displayed.

A liquid crystal used in a known liquid crystal display element, when a direct-current component is applied to the liquid crystal, its reliability is lowered and an image-sticking phenomenon occurs on a display screen due to polarization of liquid crystal molecules. In order to avoid the image-sticking phenomenon, a voltage to be applied to the pixel electrode is inverted with respect to a common electrode potential as a center, to thereby perform an alternating current (AC) drive.

In the liquid crystal display element thus described, because of high density of the pixel electrodes to achieve a high definition display image, that is, miniaturization of a pixel transistor, a parasitic capacitance in a pixel unit is increased and a signal current leakage occurs in the pixel unit. Further, since the liquid crystal display element is required to achieve a display image with high luminance, a light strength to be irradiated to the pixel unit is increased, thereby resulting in an abnormal current (leakage current) due to light leakage from the pixel unit. The leakage current changes voltages and causes the flicker due to luminance change and the image-sticking due to the application of a direct-current component.

Accordingly, in order to address the above-mentioned disadvantages, there has been proposed a method of applying a correction voltage, which is formed by previously adding a correction value to an image signal, to correspond to the parasitic capacitance of a pixel transistor and differences in substrate characteristics between a pixel electrode and a common electrode (for example, Patent document 1: Japanese Unexamined Patent Application Publication No. 2002-189460).

However, since the method disclosed in the Patent document 1 does not consider a gray scale of a video signal and a voltage polarity associated with the video signal, this is not sufficient as a correction method.

Further, a so-called single-plate display apparatus, which is equipped with a single liquid crystal display element, has a configuration in which a light from a light source is separated into three primary colors of RGB, inclined at a certain angle, and passed through a predetermined pixel of the liquid crystal display element having no color filter, and projected, by a dichroic mirror. Consequently, an incident angle of the light to be entered into the liquid crystal display element is varied according to a wavelength. However, since the variation of the incident angle is not considered, this is not sufficient as a correction method.

### SUMMARY OF THE INVENTION

Accordingly, it is desirable to provide a display apparatus which corrects a voltage to prevent a leakage current, and which prevents the generation of flicker due to the luminance change and the degradation in image quality of display image, and also to provide a method for driving the display apparatus.

In accordance with one embodiment of the present invention, there is provided a display apparatus which is an active matrix liquid crystal display element, including: a light source; a liquid crystal display element; and a signal generating unit configured to generate a signal for driving the liquid crystal display element in response to an image signal to be inputted, to light-modulate the incident light. The liquid crystal display element includes a first substrate having a first electrode, a second substrate which is opposed to the first substrate and has a second electrode, and a liquid crystal layer held between the first and second electrode. The signal generating unit includes a first correction value calculation unit, a second correction value calculation nit, a third correction value calculation unit, and a correction value calculation unit. The first correction value calculation unit detects a gray scale of an image signal which is inputted to a pixel of the liquid crystal display element and calculates a first correction value on the basis of the detected gray scale. The second correction value calculation unit detects a polarity of a voltage component to be applied between the first substrate and the second substrate in response to the image signal which is inputted to the pixel of the liquid crystal display element and calculates a second correction value on the basis of the detected polarity. The third correction value calculation unit detects a wavelength and/or luminance of the light emitted from the light source to the pixel of the liquid crystal display element and calculates a third correction value on the basis of the detected wavelength and/or luminance. The correction value calculation unit calculates a correction value for correcting the voltage component on the basis of the first to third correction values calculated by the first to third correction value calculation units.

In accordance with another embodiment of the present invention, there is provided a display apparatus which is an active matrix liquid crystal display element, including: a light source; a color separation unit for color-separating a light emitted from the light source; a liquid crystal display element for light-modulating each light color-separated by the color separation unit; and a signal generating unit configured to generate a signal for driving the liquid crystal display element in response to an image signal to be inputted, to light-modulate an incident light. The liquid crystal display element includes a first substrate having a first electrode, a second substrate which is opposed to the first substrate and has a second electrode, and a liquid crystal layer held between the first and second substrates. The signal generating unit includes a first correction value calculation unit, a second correction value calculation unit, a third correction value calculation unit, a fourth correction value calculation unit, and a correction value calculation unit. The first correction value calculation unit detects a gray scale of an image signal which is inputted to a pixel of the liquid crystal display element and calculates a first correction value on the basis of the detected gray scale. The second correction value calculation unit detects a polarity of a voltage component to be applied between the first substrate and the second substrate in response to the image signal which is inputted to the pixel of the liquid crystal display element and calculates a second correction value on the basis of the detected polarity. The third correction value calculation unit detects a wavelength and/or luminance of the light emitted from the light source to the pixel of the liquid crystal display element through the color separation unit and calculates a third correction value on the basis of the detected wavelength and/or luminance. The fourth correction value calculation unit detects an incident angle of light emitted from the light source to the pixel of the liquid crystal display element through the color separation unit and calculates a fourth correction value on the basis of the detected incident angle. The correction value calculation unit calculates a correction value for correcting the voltage component on the basis of the first fourth correction values calculated by the first to fourth correction value calculation units.

In accordance with a further embodiment of the present invention, there is provided a driving method for driving a display apparatus which is an active matrix liquid crystal display element, including a light source, a liquid crystal display element for light-modulating a light emitted from the light source and including a first substrate having a first electrode, a second substrate which is opposed to the first substrate and has a second electrode, and a liquid crystal layer held between the first and second substrates, and a signal generating unit configured to generate a signal to drive the liquid crystal display element in response to an image signal to be inputted, to light-modulate the incident light. The method for driving the display apparatus includes a first correction value calculating step, a second correction value calculating step, a third correction value calculating step, and a correction value calculating step. The first correction value calculating step includes steps of detecting a gray scale of an image signal which is inputted to a pixel of the liquid crystal display element and calculating a first correction value on the basis of the detected gray scale. The second correction value calculating step includes steps of detecting a polarity of a voltage component to be applied between the first substrate and the second substrate in response to the image signal which is inputted to the pixel of the liquid crystal display element and calculating a second correction value on the basis of the detected polarity. The third correction value calculating step includes steps of detecting a wavelength and/or luminance of the light emitted from the light source to the pixel of the liquid crystal display element and calculating a third correction value on the basis of the detected wavelength and/or luminance. The correction value calculating step includes a step of calculating a correction value for correction value for correcting the voltage component on the basis of the first to fourth correction values calculated by the first to fourth correction value calculating steps.

In accordance with yet another embodiment of the present invention, there is provided a driving method for driving a display apparatus which is an active matrix liquid crystal display element, including a light source, a color separation unit for color-separating a light emitted from the light source, a liquid crystal display element for light-modulating each light color-separated by the color separation unit and including a first substrate having a first electrode, a second substrate which is opposed to the first substrate and has a second electrode, and a liquid crystal layer held between the first and second substrates, a signal generating unit for generating a signal for driving the liquid crystal display element in response to an image signal to be inputted, to light-modulate the incident light. The method for driving the display apparatus includes a first correction value calculating step, a second correction value calculating step, a third correction value calculating step, a fourth correction value calculating step, and a correction value calculating step. The first correction value calculating step includes steps of detecting a gray scale of an image signal which is inputted to a pixel of the liquid crystal display device element and calculating a first correction value on the basis of the detected gray scale. The second correction value calculating step includes steps of detecting a polarity of a voltage component to be applied between the first substrate and the second substrate in response to the image signal which is inputted to the pixel of the liquid crystal display element and calculating a second correction value on the basis of the detected polarity. The third correction value calculating step includes steps of detecting a wavelength and/or luminance of the light emitted from the light source to the pixel of the liquid crystal display element through the color separation unit and calculating a third correction value on the basis of the detected wavelength and/or luminance. The fourth correction value calculating step includes steps of detecting an incident angle of light emitted from the light source to the pixel of the liquid crystal display element through the color separation unit and calculating a fourth correction value on the basis of the detected incident angle. The correction value calculating step includes a step of calculating a correction value for correcting the voltage component on the basis of the first to fourth correction values calculated by the first to fourth correction value calculating steps.

According to embodiments of the present invention, the plurality of correction units calculate correction values that correct an abnormal current generated in a voltage component to be applied between the first electrode and the second electrode. Accordingly, it is possible to prevent the degradation in image quality due to the abnormal current, the generation of flicker due to luminance change, and the image-sticking due to applying a direct-current component, so that the degradation in quality of the liquid crystal can be prevented.

The above summary of the present invention is not intended to describe each illustrated embodiment or every implementation of the present invention. The figures and the detailed description which follow more particularly exemplify these embodiments.

### BRIEF DESCRIPTION OF THE DRAWINGS

FIG. 1 is a schematic diagram showing a display apparatus to which one embodiment of the present invention is applied;

FIG. 2 is a cutaway perspective view showing a liquid crystal panel of a display apparatus to which one embodiment of the present invention is applied;

FIG. 3 is a circuit diagram illustrating a display apparatus to which one embodiment of the present invention is applied;

FIG. 4 is a block diagram illustrating a signal processing circuit;

FIG. 5 is a diagram showing that an amount of leakage is varied according to a gray scale;

FIG. 6 is a diagram showing that an amount of leakage is varied according to a polarity;

FIG. 7 is a diagram showing that an amount of leakage is varied according to a wavelength;

FIG. 8 is a diagram showing that an amount of leakage is varied according to an incident angle; and

FIG. 9 is a schematic diagram showing a state where a voltage component is corrected by a calculated correction value.

### DETAILED DESCRIPTION OF EMBODIMENTS

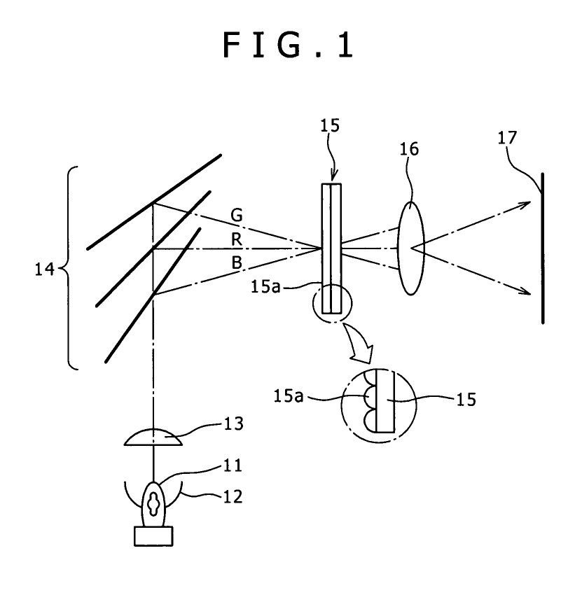

A display apparatus to which one embodiment of the present invention is applied will be described in detail with reference to the drawings. A display apparatus 1 to which one embodiment of the present invention is applied is a so-called single-plate display apparatus having a single liquid crystal panel 15, which is a liquid crystal display element. The display apparatus 1 includes, as shown in FIG. 1, a light source 11, a reflector 12 for reflecting a light emitted from the light source 11 and projecting it in a desired direction, a condenser lens 13 for receiving the light from the light source 11 and condensing the incident light to emit, a color separation unit 14 for color-separating the light from the condenser lens 13, a liquid crystal panel 15 for receiving the light from the color separation unit 14, and a projection lens 16 for projecting the light from the liquid crystal panel 15 by enlarging. The display apparatus 1 displays a desired image in response to an image signal inputted to the liquid crystal panel to drive it.

The light source 11 emits a white light containing a red light, a blue light, and a green light, which are necessary for displaying a color image. The reflector 12 reflects and condenses the light emitted from the light source 11. A lamp is used as a light emitter of the light source 11, for example, an extra-high pressure mercury lamp, a halogen lamp, a metal halide lamp, and a xenon lamp. The reflector 12 preferably has a shape that can achieve a high efficiency of condensing light, for example, a rotational symmetric concave shape, such as a rotary elliptical mirror, and a paraboloid of revolution. A luminous point of the light emitter as the light source 11 is arranged at a focal position of the concave shaped reflector 12.

The white light emitted from the light emitter of the light source 11 is projected toward the condenser lens 13 by the reflector 12. The condenser lens 13 condenses the incident light from the reflector 12 and emits it to the color separation unit 14 at a subsequent stage.

The color separation unit 14 color-separates the light from the condenser lens 13 into three primary colors of a red light (R), a green light (G), and a blue light (B). The color separation unit 14 includes a first dichroic mirror 14B, a second dichroic mirror 14R, and a reflecting mirror 14G, which are being arranged in the order on a light path of the light from the light source 11.

The first dichroic mirror 14B reflects only the blue light (B) contained in the light from the light source 11 and transmits the other color light. The second dichroic mirror 14R reflects only the red light (R) contained in the light transmitted from the first dichroic mirror 14B and transmits other color light. The reflecting mirror 14G reflects the light transmitted from the second dichroic mirror 14R. The light reflected by these mirrors 14R, 14G, and 14B is emitted toward the liquid crystal panel 15.

Although the details will be described later, the liquid crystal panel 15 is a modulator for modulating the incident light in response to the image signal, is a so-called active matrix liquid crystal display element, and is a transmissive liquid crystal display element that has different surfaces into/from which the incident light enters/outgoes. The liquid crystal panel 15 includes a microlens array 15a which condenses the light emitted from the color separation unit 14 to a predetermined position and increases a brightness property of the light at the previous stage. The light transmitted through the liquid crystal panel 15 is emitted to the projection lens 16 at the subsequent stage.

The projection lens 16 includes a plurality of lenses and has a zoom function for adjusting a size of an image to be projected on a screen 17 and a focusing function.

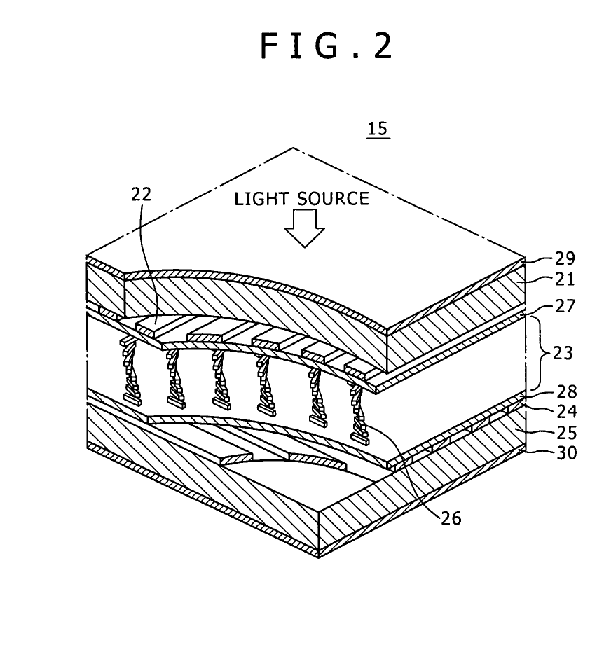

Next, the liquid crystal panel 15 will be explained. The liquid crystal panel 15 is, as shown in FIG. 2, a so-called transmissive liquid crystal panel, and includes a pixel electrode substrate 21 on which a transparent pixel electrode 22 is formed to which a signal voltage according to a video signal is applied, and a counter substrate 25 having an counter electrode 24 arranged to oppose to the pixel electrode substrate 21 with a liquid crystal layer 23 therebetween. The liquid crystal panel 15 is configured as, for example, an active matrix liquid crystal display element which performs a frame inversion driving for inverting a voltage to be applied to each pixel electrode 22 with respect to a counter electrode voltage, for each frame.

The liquid crystal layer 23 includes a liquid crystal 26 sealed in a space formed by the pixel electrode substrate 21, the counter substrate 25, and a seal material (not shown) which encloses the periphery in a frame shape at a position between the pixel electrode substrate 21 and the counter substrate 25.

The pixel electrode substrate 21 is made of a transparent material, such as quartz, glass, and plastic, and includes a thin film transistor (TFT) and the pixel electrode 22 connected to the TFT provided for each pixel, on the inside surface opposed to the counter substrate 25. The pixel electrode 22 is made of a transparent conducting film such as an indium-tin-oxide (ITO) film. On the inside surface of the pixel electrode substrate 21, an alignment film 27 made of, for example, an inorganic material is provided to cover the pixel electrode 22 for aligning a molecular group of the liquid crystal 26 in a predetermined direction.

Similar to the pixel electrode substrate 21, the counter substrate 25 is made of a transparent material, such as quartz, glass, plastic, and includes the counter electrode 24 provided on the inside surface opposed to the pixel electrode substrate 21. The counter electrode 24 is made of a transparent conducting film such as an ITO film. Further, on the inside surface of the counter substrate 25, an alignment film 28 made of, for example, an inorganic material is provided to cover the pixel electrode 24 for aligning a molecular group of the liquid crystal 26 in a predetermined direction.

The liquid crystal panel 15 includes a first polarizing plate 29 and a second polarizing plate 30 provided on the light entering side and light outgoing side, respectively, and the first and second polarizing plates 29, 30 are arranged to sandwich the pixel electrode substrate 21 and the counter substrate 25 of the liquid crystal panel 15 therebetween.

The first polarizing plate 29 is provided on the light entering side of the liquid crystal panel 15, and has a function for increasing the degree of polarization of a linearly polarized light emitted from the light source 11. The second polarizing plate 30 is provided on the light outgoing side of the liquid crystal panel 15, and has a function for increasing the degree of polarization of a modulated light from the liquid crystal panel 15 similar to the first polarizing plate 29.

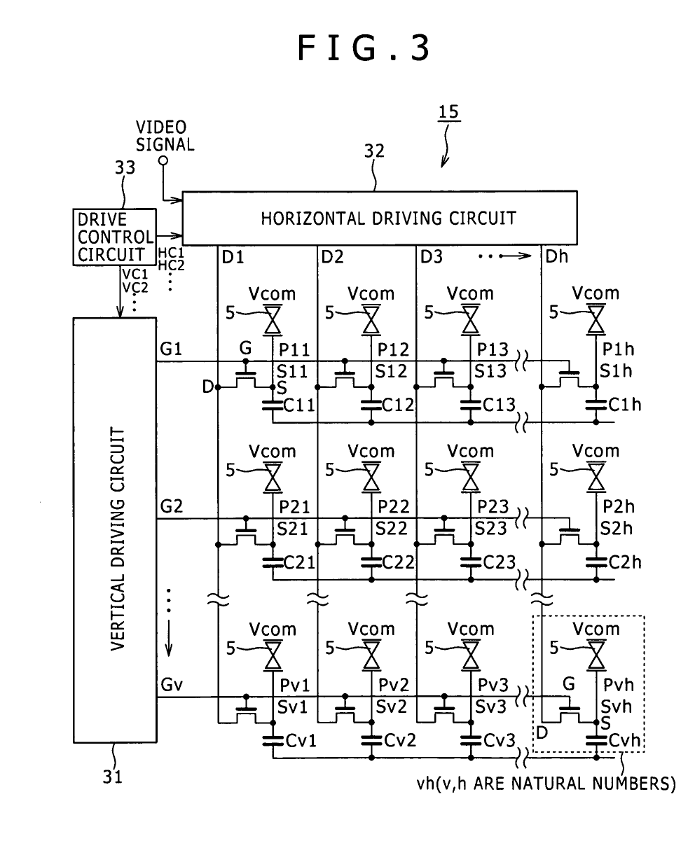

A drive circuit configuration of the liquid crystal panel 15 will subsequently be described with reference to FIG. 3. As shown in FIG. 3, the liquid crystal panel 15 includes a plurality of pixel switches Svh (where each of v and h is a natural number) arranged in a matrix form on the pixel electrode substrate 21, a pixel cell driving circuit including a pixel capacitance Cvh, a pixel electrode Pvh (the pixel electrode 22 in FIG. 2), a vertical driving circuit 31 with a shift register, a horizontal driving circuit 32, and a drive control circuit 33 for controlling the drive, such as a driving timing, of the vertical driving circuit 31 and the horizontal driving circuit 32. In the liquid crystal panel 15, a common potential Vcom is applied to the counter electrode 24 of the counter substrate 25. In the liquid crystal panel 15 thus configured, a display area in the liquid crystal layer 23 corresponding to each pixel electrode Pvh becomes a pixel cell vh representing one pixel.

A source (S) of the pixel switch Svh is connected to the common electrode (counter electrode 24 in FIG. 2) through the pixel capacitance Cvh. The pixel electrode Pvh is connected to the connection point of the source of the pixel switch Svh and the pixel capacitance Cvh. Further, a gate (G) of the pixel switch Svh is connected to a gate line Gv led out from the vertical driving circuit 31, and a drain (D) is connected to the data line Dh led out from the horizontal driving circuit 32.

The vertical driving circuit 31 includes a shift register which sequentially scans gate lines G1, G2 . . . Gv led out from the shift register in the horizontal direction and connected to the gate of the pixel switch Svh of the pixel cell vh. The horizontal driving circuit 32 includes a shift register which sequentially scans data lines D1, D2 . . . Dh led out from the shift register in the horizontal direction and connected to the drain of the pixel switch Svh of the pixel cell vh.

The drive control circuit 33 includes a vertical driving timing pulse generating circuit for supplying vertical shift clocks VC1, VC2 . . . VCv to the shift register of the vertical driving circuit 31. The drive control circuit 33 includes a horizontal driving timing pulse generating circuit for supplying horizontal shift clocks HC1, HC2, . . . HCh to the shift register of the horizontal driving circuit 32.

In the liquid crystal panel 15 thus configured, electric charges are written into the pixels as follows. First, when a voltage of the gate line G1 becomes high by the vertical driving circuit 31, the pixel switches S11 to Svh of a first row are turned on. After the pixel switches S11 to Svh are turned on, the data line D1 is driven by the horizontal driving circuit 32 and data (video signals) is written into the pixel capacitance C11 through the pixel switch S11.

Next, the horizontal driving circuit 32 stops the drive of the data line D1 to turn the pixel switch S11 off, and further drives the data line D2 to turn the pixel switch S12 on. With this operation, the data (video signals) written into the pixel capacitance C11 is held and written into the pixel capacitance C12 through the pixel switch S12. This operation is sequentially repeated until reaching the data line Dh, whereby the data is written into the pixels of the first row in the horizontal direction.

After the completion of data writing into the pixels of the first row in the horizontal direction, the vertical driving circuit 31 allows the gate line G1 to fall, and the gate line G2 to rise. In response to the rise of the gate line G2, the vertical driving circuit 31 sequentially drives the data line D1 to Dh, and writes the data into the pixels in the horizontal direction described as above. This operation is sequentially repeated until reaching the gate line Gv, whereby the data (video signals) are written into the all pixels of the liquid crystal panel 15.

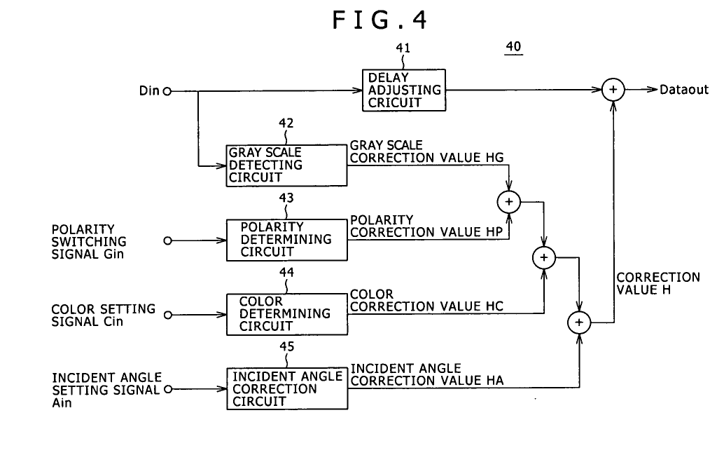

Next, the signal processing circuit of the liquid crystal panel 15 thus configured will be described. In the signal processing circuit 40 of the liquid crystal panel 15, as shown in FIG. 4, the image signal is inputted from a terminal Din and supplied to a delay adjusting circuit 41 and a gray scale detecting circuit 42. The signal processing circuit 40 includes a polarity determining circuit 43 to which a polarity switching signal is supplied, a color determining circuit 44 to which a color setting signal is supplied, and an incident angle correction circuit 45 to which an incident angle setting signal is supplied.

The delay adjusting circuit 41 receives the image signal through the input terminal Din and adjusts and controls an amount of delay between the image signal and each correction signal.

Similar to the delay adjusting circuit 41, the gray scale detecting circuit 42 receives the image signal through the input terminal Din, detects the gray scale of the image signal, and calculates a gray scale correction value HG on the basis of the detected gray scale. As shown in FIG. 5, an amount of leakage is increased or decreased according to the magnitude of voltage value which is varied depending on the gray scale. The gray scale detecting circuit 42 detects the gray scale, that is, the magnitude of voltage value, and calculates the appropriate gray scale correction value HG that reduces the amount of leakage when the voltage value is large so as to be equal to the amount of leakage when the voltage value is small.

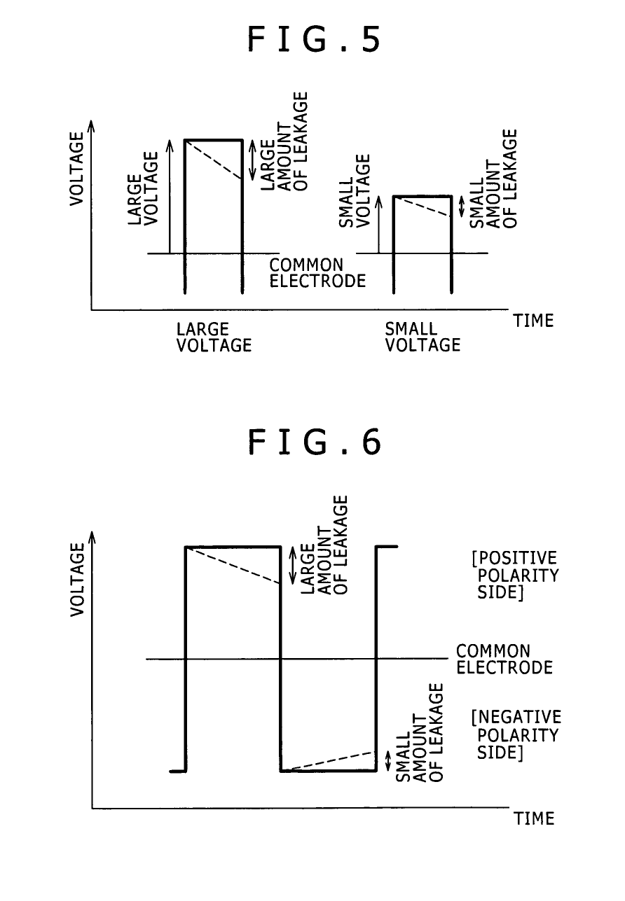

The polarity determining circuit 43 receives the polarity switching signal for switching the polarity with respect to a predetermined potential level in every cycle of the vertical scan performed by the vertical driving circuit 31, through the input terminal Gin, determines whether the voltage component has a positive polarity or a negative polarity according to the polarity switching signal to be supplied, and calculates a polarity correction value HP. As shown in FIG. 6, since the amount of leakage is varied depending on the polarity, that is, the amount of leakage is larger when the voltage is at the positive polarity side than at the negative polarity side, the polarity determining circuit 43 determines the polarity and calculates the polarity correction value HP that corrects the amount of leakage when the voltage is at the positive polarity side so as to be equal to the amount of leakage when the voltage is at the negative polarity side.

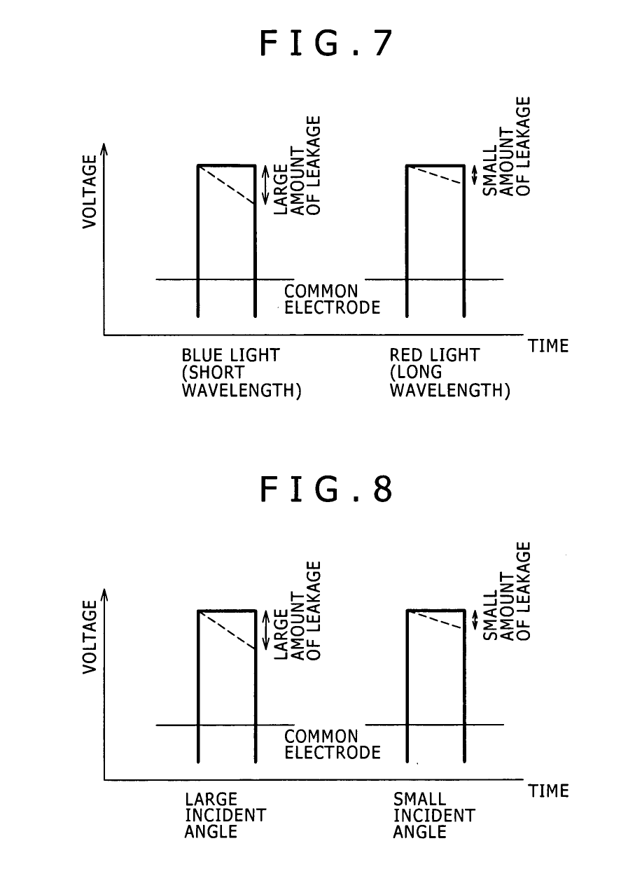

The color determining circuit 44 receives the color setting signal corresponding to the image signal to be supplied, through an input terminal Cin, determines colors of the image signal according to the supplied color setting signal. Specifically, the color determining circuit 44 detects and determines a wavelength/luminance of the image signal, and calculates a correction value HC on the basis of the detected wavelength/luminance. As shown in FIG. 7, since the amount of leakage is varied depending on the wavelength of the light, that is, the leakage amount is larger when the light has a short wavelength than the light has a long wavelength, the color determining circuit 44 detects and determines the color (wavelength/luminance), and calculates the correction value HC that corrects the amount of leakage when the light has a short wavelength so as to be equal to the amount of leakage when the light has a long wavelength.

The incident angle correction circuit 45 receives the incident angle setting signal corresponding to the image signal to be supplied, through an input terminal Ain, detects an incident angle of the light to be entered into each pixel cell vh according to the supplied incident angle setting signal, and calculates an incident angle correction value HA on the basis of the detected incident angle. As shown in FIG. 1, the incident angle of the light entered into the pixel cell vh is varied according to each mirror of the color separation unit 14. At this time, as shown in FIG. 8, since the amount of leakage is varied depending on the incident angle, that is, the amount of leakage is larger when the incident angle of the light is large, the correction circuit 45 detects the incident angle of the light and calculates the incident angle correction value HA that corrects the amount of leakage when the incident angle is large so as to be equal to the amount of leakage when the incident angle is small.

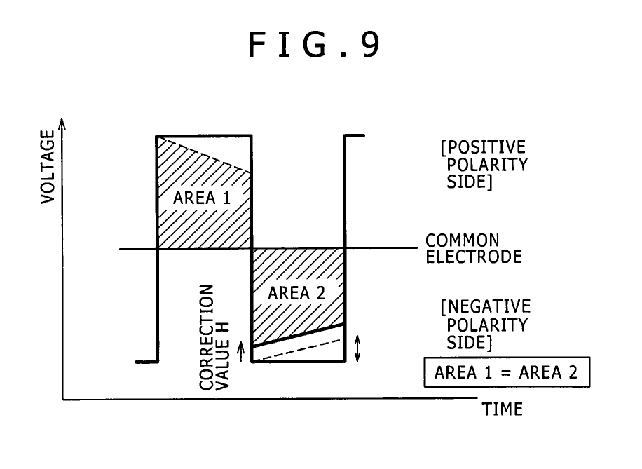

In the signal processing circuit 40, the correction value H obtained by adding the correction values HG, HP, HC, and HA, which are calculated by each of circuits 42 to 45, is added to the image signal delay-controlled by the delay adjusting circuit 41, so that integrated values at the positive polarity side and at the negative polarity side are corrected to be equal to each other, as shown in FIG. 9.

Although the value at the negative polarity side is corrected by the correction value H in the case of FIG. 9, it is not limited to this, and the value at the positive polarity side may be corrected, or, the values of both polarities may be corrected.

In the display apparatus 1 thus configured, the gray scale, the polarity, the color (wavelength, luminance), and the incident angle, which are considered as factors of the leakage current, are taken into account, and the correction values corresponding to these values can be calculated. As a result, it is possible to surely prevent the degradation in image quality, the generation of flicker due to luminance change, the image-sticking caused by applying the direct-current component, so that the liquid crystal can be prevented from degrading the quality.

It is noted that, in the present invention, the embodiment of the so-called transmissive liquid crystal display element has been described, however, it is not limited to this, and a reflective liquid crystal display element may be used. In that case, the amount of leakage may be opposite to the case of the present embodiment, that is, the amount of leakage is small when the light has short wavelength and the amount of leakage is large when the light has long wavelength, according to the configuration of the liquid crystal display element, although the present description explains the case where the amount of leakage is large when the light has short wavelength and the amount of leakage is small when the light has long wavelength.

It should be understood by those skilled in the art that various modifications, combinations, sub-combinations and alternations may occur depending on design requirements and other factors insofar as they are within the scope of the appended claims or equivalents thereof.

What is claimed is:

1. A display apparatus which is an active matrix liquid crystal display element, comprising:
a light source;
a liquid crystal display element for light-modulating a light emitted from the light source, and including a first substrate having a first electrode, a second substrate which is opposed to the first substrate and has a second electrode, and a liquid crystal layer held between the first and second substrates;
signal generating means for generating a signal for driving the liquid crystal display element in response to an image signal to be inputted, to light-modulate the incident light; and
wherein the signal generating means includes:
means for detecting a gray scale of an image signal which is inputted to a pixel of the liquid crystal display element and calculating a first correction value on the basis of the detected gray scale;
means for detecting a polarity of a voltage component to be applied between the first electrode and the second electrode in response to the image signal which is inputted to the pixel of the liquid crystal display element and calculating a second correction value on the basis of the detected polarity;
means for detecting a wavelength and/or luminance of the light emitted from the light source to the pixel of the liquid crystal display element and calculating a third correction value on the basis of the detected wavelength and/or luminance; and
means for calculating a correction value for correcting the voltage component on the basis of the first to third correction values calculated by the first to third correction means.

2. A display apparatus which is an active matrix liquid crystal display element, comprising:
a light source;
a color separation unit for color-separating a light emitted from the light source;
a liquid crystal display element for light-modulating each light which is color-separated by the color separation unit, and including the liquid crystal display element including a first substrate having a first electrode, a second substrate which is opposed to the first substrate and has a second substrate, and a liquid crystal layer held between the first substrate and the second substrate;
signal generating means for generating a signal for driving the liquid crystal display element in response to an image signal to be inputted, to light-modulate an incident light; and
wherein the signal generating means includes:
means for detecting a gray scale of an image signal which is inputted to a pixel of the liquid crystal display element and calculating a first correction value on the basis of the detected gray scale;
means for detecting a polarity of a voltage component to be applied between the first substrate and the second electrodes in response to the image signal which is inputted to the pixel of the liquid crystal display element and calculating a second correction value on the basis of the detected polarity;
means for detecting a wavelength and/or luminance of the light emitted from the light source to the pixel of the liquid crystal display element through the color separation unit and calculating a third correction value on the basis of the detected wavelength and/or luminance;
means for detecting an incident angle of light emitted from the light source to the pixel of the liquid crystal display element through the color separation unit and calculating a fourth correction value on the basis of the detected incident angle; and
means for calculating a correction value for correcting the voltage component on the basis of the first to fourth correction values calculated by the first to fourth correction means.

3. A driving method for driving a display apparatus which is an active matrix liquid crystal display element, including a light source, a liquid crystal display element for light-modulating a light emitted from the light source and including a first substrate having a first electrode, a second substrate which is opposed to the first substrate and has a second electrode, and a liquid crystal layer held between the first and the second substrates, and signal generating means for generating a signal to drive the liquid crystal display element in response to an image signal to be inputted, to light-modulate the incident light, the driving method comprising:
a first correction value calculating step of detecting a gray scale of an image signal which is inputted to a pixel of the liquid crystal display element and calculating a first correction value on the basis of the detected gray scale;
a second correction value calculating step of detecting a polarity of a voltage component to be applied between the first electrode and the second electrode in response to the image signal to be input to the pixel of the liquid crystal display element and calculating a second correction value on the basis of the detected polarity;
a third correction value calculating step of detecting a wavelength and/or luminance of the light emitted from the light source to the pixel of the liquid crystal display element and calculating a third correction value on the basis of the detected wavelength and/or luminance; and
a correction value calculating step of calculating a correction value for correcting the voltage component on the basis of the first to third correction values calculated by the first to third correction value calculating steps.

4. A driving method for driving a display apparatus which is an active matrix liquid crystal display element, including a light source, a color separation unit for color-separating a light emitted from the light source, a liquid crystal display element for light-modulating each light color-separated by the color separation unit and including a first substrate having a first electrode, a second substrate which is opposed to the first substrate and has a second electrode, and a liquid crystal layer held between the first and the second substrates, a signal generating unit which generates a signal for driving the liquid crystal display element in response to an image signal to be inputted, to light-module the incident light, the driving method comprising:
a first correction value calculating step of detecting a gray scale of an image signal which is inputted to a pixel of the liquid crystal display element and calculating a first correction value on the basis of the detected gray scale;
a second correction value calculating step of detecting a polarity of a voltage component to be applied between the first electrode and the second electrode in response to the image signal which is inputted to the pixel of the liquid crystal display element and calculating a second correction value on the basis of the detected polarity;
a third correction value calculating step of detecting a wavelength and/or luminance of the light emitted from the light source to the pixel of the liquid crystal display element through the color separation unit and calculating a third correction value on the basis of the detected wavelength and/or luminance;
a fourth correction value calculating step of detecting an incident angle of light emitted from the light source to the pixel of the liquid crystal display element through the color separation unit and calculating a fourth correction value on the basis of the detected the incident angle; and
a correction value calculating step of calculating a correction value for correcting the voltage component on the basis of the first to fourth correction values calculated by the first to fourth correction value calculating steps.

5. A display apparatus which is an active matrix liquid crystal display element, comprising:
a light source;
a liquid crystal display element for light-modulating a light emitted from the light source, the liquid crystal display element including a first substrate having a first electrode, a second substrate which is opposed to the first substrate and has a second electrode, and a liquid crystal layer held between the first and second substrates;
a signal generating unit configured to generate a signal for driving the liquid crystal display element in response to an image signal to be inputted, to light-modulate the incident light; and
wherein the signal generating unit includes:
a first correction value calculation unit configured to detect a gray scale of an image signal which is inputted to a pixel of the liquid crystal display element and calculate a first correction value on the basis of the detected gray scale;
a second correction value calculation unit configured to detect a polarity of a voltage component to be applied between the first electrode and the second electrode in response to the image signal which is inputted to the pixel of the liquid crystal display element and calculate a second correction value on the basis of the detected polarity;
a third correction value calculation unit configured to detect a wavelength and/or luminance of the light emitted from the light source to the pixel of the liquid crystal display element and calculate a third correction value on the basis of the detected wavelength and/or luminance; and
a correction value calculation unit configured to calculate a correction value for correcting the voltage component on the basis of the first to third correction values calculated by the first to third correction value calculation units.

6. A display apparatus which is an active matrix liquid crystal display element, comprising:
a light source;
a color separation unit for color-separating a light emitted from the light source, the liquid crystal display element including a first substrate having a first electrode, a second substrate which is opposed to the first substrate and has a second electrode, and a liquid crystal layer held between the first substrate and the second substrate;
a liquid crystal display element for light-modulating each light which is color-separated by the color separation unit;
a signal generating unit configured to generate a signal for driving the liquid crystal display element in response to an image signal to be inputted, to light-modulate an incident light; and
wherein the signal generating unit includes:
a first correction value calculation unit configured to detect a gray scale of an image signal which is inputted to a pixel of the liquid crystal display element and calculate a first correction value on the basis of the detected gray scale;
a second correction value calculation unit configured to detect a polarity of a voltage component to be applied between the first substrate and the second electrodes in response to the image signal which is inputted to the pixel of the liquid crystal display element and calculate a second correction value on the basis of the detected polarity;
a third correction value calculation unit configured to detect a wavelength and/or luminance of the light emitted from the light source to the pixel of the liquid crystal display element through the color separation unit and calculate a third correction value on the basis of the detected wavelength and/or luminance;
a fourth correction value calculation unit configured to detect an incident angle of light emitted from the light source to the pixel of the liquid crystal display element through the color separation unit and calculate a fourth correction value on the basis of the detected incident angle; and
a correction value calculation unit for calculating a correction value for correcting the voltage component on the basis of the first to fourth correction values calculated by the first to fourth correction value calculation units.
